(19) United States
(12) Patent Application Publication
(10) Pub. No.: US 2026/0044887 A1
(43) Pub. Date: Feb. 12, 2026

(54) METHOD AND SYSTEM FOR EFFICIENT CLIENT SERVER COMMUNICATION

(71) Applicant: Ocado Innovation Limited, Hatfield (GB)

(72) Inventor: Jonathon Lee READ, Bedford (GB)

(21) Appl. No.: 18/799,920

(22) Filed: Aug. 9, 2024

(51) Int. Cl. G06Q 30/0601

(52) U.S. Cl. CPC G06Q 30/0629; G06Q 30/0633

(57) ABSTRACT

Certain aspects of the disclosure provide for reducing the number of interactions and/or communications between a client device and server device, and for example, when placing an order on a client and server system for processing user interactions.

### INTRODUCTION

### Technical Field

Aspects of the present disclosure relate to a method and system of reducing the number of interactions and/or communications between a client device and server device, for example, when conducting an electronic data transaction on a client and server system for processing user interactions.

### Background

Online shopping typically involves a client device communicating with a server device. The client device and server device are configured to form a client and server system (alternatively, client-server system) for processing user interactions, such as for conducting an electronic data transaction (e.g., on an ecommerce platform). For example, a client device may be used to search for an item available on the ecommerce platform. The search can return a number of items, after which one of the items is added to an online basket or cart to order the item. Although this process is relatively straightforward, it can be problematic. For example, certain users, such as a first time user/customer, may find navigating the user interface on the client device unfamiliar. The time taken to familiarize with the user interface to search and add items to the basket can prevent adoption of the (in this example) ecommerce platform. Further, the search process may be sensitive to the search term(s) used, which can vary customer-to-customer. Hence, a user may have to try several search terms to return a preferred item. When the number of items that a user wishes to order increases, such as a grocery order, the above issues are made worse, and increase the likelihood that the user will abandon the order process. Further, this results in significant communication, processing, and network burden on and between the client and server devices when conducting the electronic data transaction (e.g., placing an order through the ecommerce platform).

### SUMMARY

In an aspect, a computer-implemented method includes: receiving, from a first device, a file comprising a list of items; processing, using a first trained model, the file to extract the list of items; searching, for each item of the list of items, for at least one identical or similar item; sending, to the first device, for each item of the list of items, data associated with the searching for the at least one identical or similar item; receiving, from the first device, at least one selection of the at least one identical or similar item; and adding items corresponding to the at least one selection of the at least one identical or similar item to an order for a system for conducting an electronic data transaction.

In another aspect, a computer-implemented method includes: prompting a user to upload a file comprising a list of items; sending the file to a second device; receiving, from the second device, for each item of the list of items, data associated with searching for at least one identical or similar item; displaying, for each item of the list of items, the data associated with the searching for at least one identical or similar item; and sending at least one selection of the at least one identical or similar items to the second device to add items corresponding to the at least one selection of the at least one identical or similar item to an order for a system for conducting an electronic data transaction.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 shows a client and server system for processing user interactions.

FIG. 2 shows a method carried out on a server of the client and server system for processing user interactions.

FIG. 3 shows a method carried out on a client device of the client and server system for processing user interactions.

FIG. 4 shows an example of logical elements used in the methods of FIGS. 2 and 3.

FIGS. 5A-F show an example user interface of the client device of FIG. 1.

FIG. 6 shows a processing system for implementing aspects described herein.

FIG. 7 shows another processing system for implementing aspects described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for reducing the number of interactions and/or communications between a client device and a server device, for example, when performing an electronic data transaction on a client and server system for processing user interactions.

A new user of a client and server system for processing user interactions typically downloads an application or loads an application (e.g., a web application) via a URL on a web browser on a first device, such as a smartphone, tablet computer, or similar device. Being unfamiliar with the application, the user may struggle to find preferred items/products. It has been found that the new user may take up to 60% longer and is twice as likely to abandon performing an electronic data transaction (e.g., placing an order through an ecommerce platform) compared to an experienced user. The extra time creates a corresponding burden and technical problem in terms of processing and communications between the first device and a second device (e.g., a server computer) forming the client and server system for processing user interactions.

Aspects described herein provide a technical solution to the aforementioned technical problem by significantly reducing the processing and communication resources required to perform the electronic data transaction, and also making it easier for a new user to perform the electronic data transaction. Specifically, beneficial technical effects of the aspects described herein include reduced processing and communication resources at both the first and second device, which beneficially reduces power consumption, extends battery life (e.g., at a mobile first device), and reduces network overhead and data usage (e.g., on a metered wireless connection).

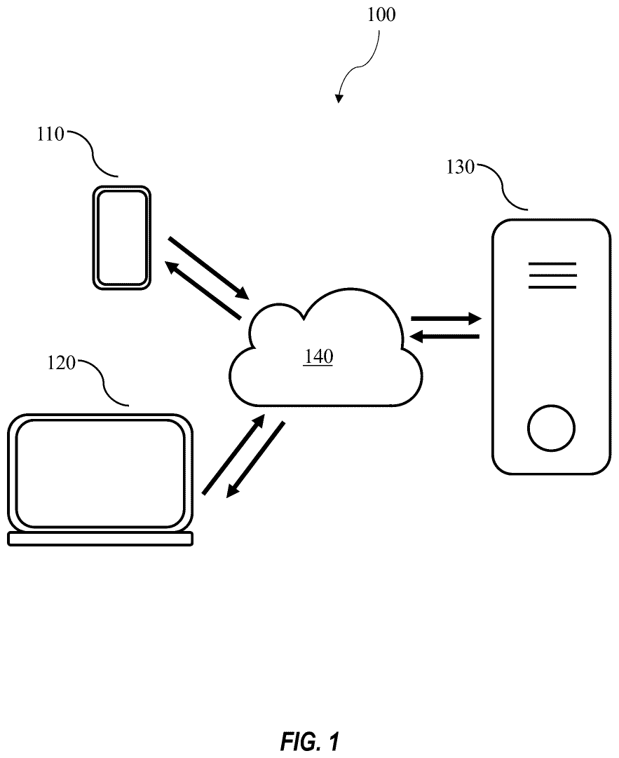

FIG. 1 shows a system 100 used for processing user interactions between client and server devices, such as for performing electronic data transactions. A client device 110 or 120, which could be a smartphone or laptop, interacts with a server device 130 via one or more networks, such as the Internet 140. The client and server devices each generally comprise one or more processing units, (e.g., central processing units, graphical processing units, tensor processing units, and others), one or more memories, and networking capabilities. In this example, both the client and server devices are configured to allow a user to place an order on an ecommerce platform. This allows the user to interact with an online store front on the client device to search and order items. The server receives and processes requests from the client device, such as search queries or adding an item to an order. The server then returns the relevant information such as the search results for display on the client device, or adds the item to a list of items for order (e.g., a “basket”, “cart”, or “trolley”). The client and server devices also interact to process payment details for the user when placing an order. Both the client and server devices are configured as described below to significantly reduce the processing and communication resources required for completing the electronic data transaction, and to make it easier for the new user to complete the electronic data transaction (e.g., place an order).

Note that while an ecommerce platform is used as one example of a client and server system for processing user interactions (such as electronic data transactions), the client and server system for processing user interactions described herein may be configured for alternative use cases.

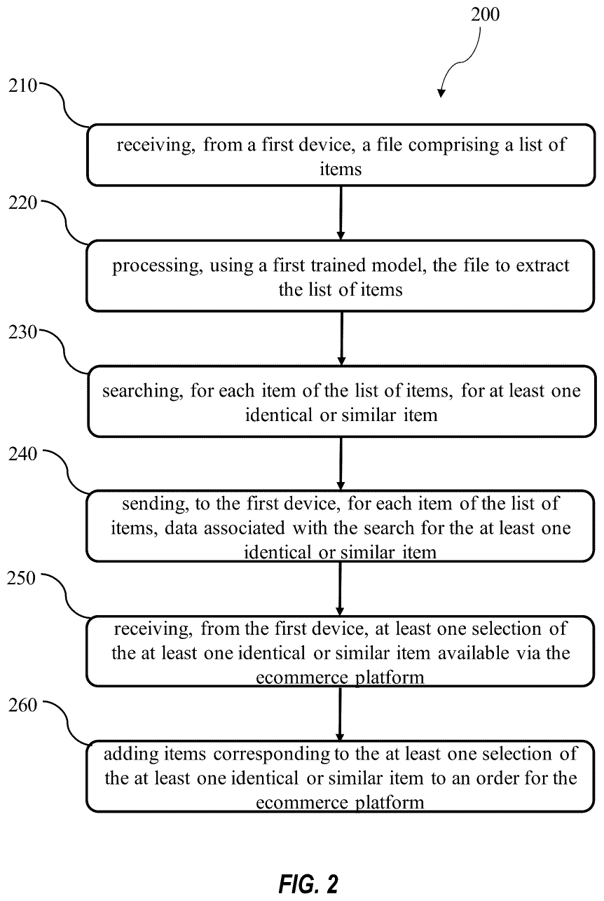

FIG. 2 shows a method 200 carried out on a server device (e.g., server device 130 of FIG. 1). Method 200 significantly reduces the processing and communication resources required for a user interaction, and improves the user experience for the interaction, such as for completing an electronic data transaction. In one example, the electronic data transaction may include completing an order on an ecommerce platform.

In step 210, the server device (e.g., a second device) receives a file from the client device (e.g., a first device). In this example, the file comprises a list of items and can take the form of an image file or text file. The file may be, for example, an online receipt, or an image of a hand written note or an in-store receipt, or a screen capture, or a plain text file. Each item on the list of items may include a description of the item, name of the item, and optionally a quantity of the item, and/or a price of the item. The description of the item may identify the product and have associated properties such as a weight and volume.

In step 220, the server processes the file using a first trained model to extract the list of items. The first trained model may take the form of a language model (e.g., a Large Language Model or “LLM”), such as one available in Model Garden on Vertex AI by Google LLC®. One such available model is Gemini 1.5 Flash.

For example, step 220 may involve using a prompt for the first trained model such as:
“Extract the product information in this receipt from a UK grocery retailer. Use json format (with names of product_name, price, pack_size, quantity, and discount). If the product name is contracted then expand it to the full name.”

An alternative prompt for the first trained model is:
“Identify the product names in this image of a receipt or shopping list. If the product name is contracted then expand it to the full name. Your output must strictly adhere to the following JSON format:{“items”: List[string]//A list of uncontracted product names extracted from the image.}”

The first trained model outputs each item in the list of items. It will be appreciated that the server may host the first trained model or communicate with a third party server that hosts the first trained model. The outputs of the first trained model correspond to search terms that can then be searched using a search function of the ecommerce platform in step 230.

In step 230, a search function searches for and returns, for each item of the list of items, at least one identical or similar item. A search function is typically implemented in the server hosting the ecommerce platform, and can process the searches for each item iteratively or as a batch containing all of the items. The similar items may be ranked where the more similar the item, the higher its ranking. Identical items are those that may have the same brand, name, volume and weight properties, for example. Similar items may be equivalent items and/or or acceptable substitutes for one another. For example, equivalent items may be the exact same items, but only vary in volume and/or weight. Substitute items may be pre-defined for each item or may be selected based on a substitution algorithm that takes into account how similar the items are in respect of different metrics, such as an item description, weight, and or volume for example. In one example, an identical item may be ranked higher than an equivalent item which may be ranked higher than a substitute item. Each equivalent item may be ranked based on similarity of price, size, and/or weight for example. Each substitute item may be ranked based on similarity and likelihood of a user accepting the item as substitute for example.

From the server's perspective, a batch searching process may be implemented on behalf of the user in a way that automatically returns results almost instantaneously. These advantages are significant when the list of items is large, such as a grocery order.

Though not depicted in FIG. 2, in some aspects, after step 220 and prior to step 230, an optional second trained model may be used to simplify the search term(s) that are used with the search function, which improves the performance of the search function when such function is optimized for broader terms. Using a specific search term when the search function is optimized for broader terms can return results that are either too specific or no results at all. For example, a search function for a grocery ecommerce platform may be designed for a user to search for a broad category such as “soft cheese.” Searching in broad terms allows the user to input short search terms and returns the maximum number of results, such as all products tagged as (e.g., having metadata associated with) soft cheese. In general, each item that can be returned by the search function is tagged with a broad category. With such a search engine, a more specific request for a type of soft cheese such as “Brand A's finest product B from region C, 12 oz” may not return any soft cheese products at all, but instead all Brand A product for example or no results at all due to lack of corresponding tag for the search term. The second trained model may also be an LLM, similar to those types of models described above with respect to the first trained model. It will be appreciated that the server may host the second trained model or communicate with a third party server that hosts the second trained model. The item extracted by the first trained model may be used as a seed for a prompt for the second trained model, such as:
“What would be a suitable search term to find products like ‘[seed]’ in an online grocery website based in the UK? Give a search term that will return many similar products. Do not give advice—just provide a search term.”

An alternative prompt for the second trained model is:
“Analyse the following item found on a UK grocery list. Your output must strictly adhere to the following JSON format:{“seed”: “{{seed}}”//The seed extracted from the grocery list. “product_name”: string//if the seed is contracted you should predict the uncontracted version. “simplified_name”: string//a version of the product name without any branding words. “search_term”: string//a search term that could be used to find the product online.”

In step 240, the server device sends to the client device for each item of the list of items, data associated with the search of step 230 for the at least one identical or similar item. Thus, in one example, for each item, an identical item, and/or equivalent items and/or acceptable substitutes for one another are displayed when available. Assuming, an identical or similar item is unavailable, the unavailability of an identical or similar item may be indicated on the first device. In response, the first device displays, for each item, an available identical or similar item or an indication that an identical or similar item is not available. The user can then, for each available item of the list of items, select at least one of the similar items by interacting with the user interface.

In step 250, the server device receives the selections of the at least one identical or similar item, which are then added to an order in step 260. Thus, in one example, for each item, at least one identical item, and/or an equivalent item and/or an acceptable substitute is added to the order. As part of adding the items to an order, the items may be moved to a so-called electronic basket or trolley or cart.

Step 260 may occur upon each selection of at least one identical or similar item and thus provide feedback that an item has been ordered on an item-by-item basis. Alternatively, step 260 may occur after selection of all identical or similar items has occurred, and thus add the items to an order using a single communication with from the client to server device, where the single communication has at least one identical item, and/or an equivalent item and/or a substitute, for each item.

After step 260, the server device may receive from the client device a confirmation and payment for the order in known ways.

In an alternative example, step 230 of FIG. 2 may instead only return one identical or similar item for each item, and automatically add the one identical or similar item to the basket for each item. That is, receipt of the file alone means the user does not have to manually select at least one identical or similar item to create the order, i.e. steps 240, 250, & 260 are omitted.

Although the above example refers to LLMs, it will be appreciated that other trained models, such as Natural Language Processing (“NLP”) models can be used. In such a case, the NLP can be trained using supervised learning. Additionally, or alternatively a combination of optical character recognition and a trained model (via supervised learning) may be used. Further, regardless of the type of trained model used, the inputs/prompts used may be tailored for the type of trained model that is used.

In one practical application, the method of FIG. 2 allows an order to be submitted using minimal client-server interactions, which in turn reduces processing and communication resources, and consequently power usage and network resources. In particular, the mere input of the file alone to the client device is sufficient to add items to the order when only one identical or similar item is returned for each item and automatically added to the order. That is, the sole transmission of the file from the client device to the server device is sufficient to place the order, which in turn reduces processing and communication resources at the first device. Even if the selection of identical or similar items to add to the order is required, this can be achieved without first having to submit search queries via the first device for each item, which in turn reduces processing and communication resources at the first device. Similarly, the mere receipt of the file alone at the server device is sufficient to add items to the order when only one identical or similar item is returned for each item and automatically added to the order. That is, the sole receipt of the file at the server device from the client device to is sufficient to place the order, which in turn reduces processing and communication resources at the second device. Even if the selection of which identical or similar items to add to the order is required, this can be achieved without first having to receive and process search queries from the first device for each item, which in turn reduces processing and communication resources at the second device.

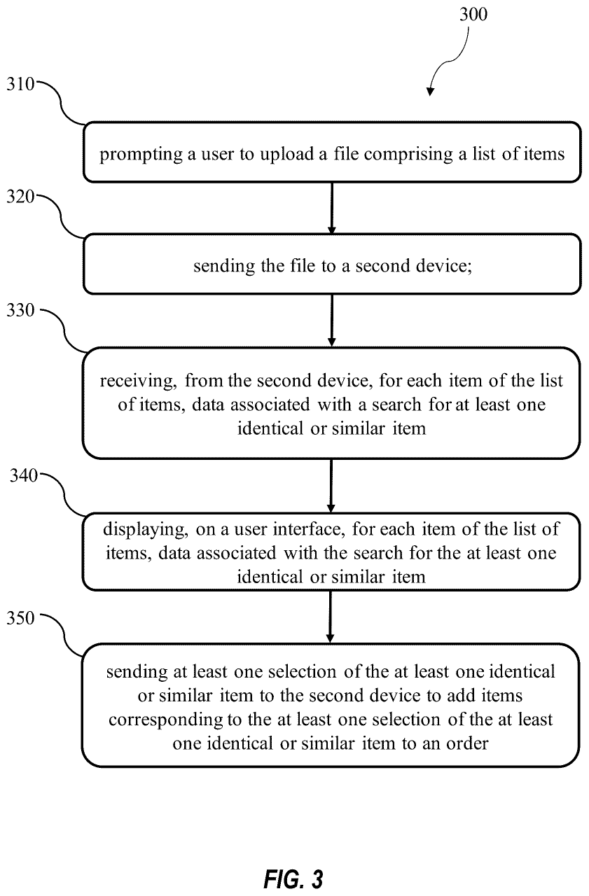

FIG. 3 shows a method 300 carried out on a client device (e.g., client devices 110 or 120 of FIG. 1). Method 300 significantly reduces the processing and communication resources required for a user interaction, and improves the user experience for the interaction, such as for completing an electronic data transaction. In one example, the electronic data transaction may include completing an order on an ecommerce platform.

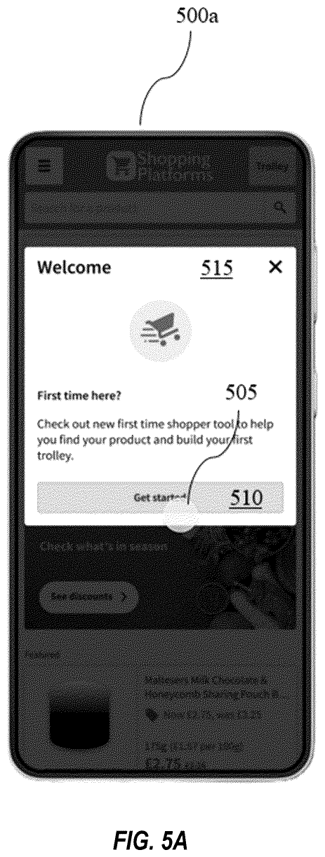

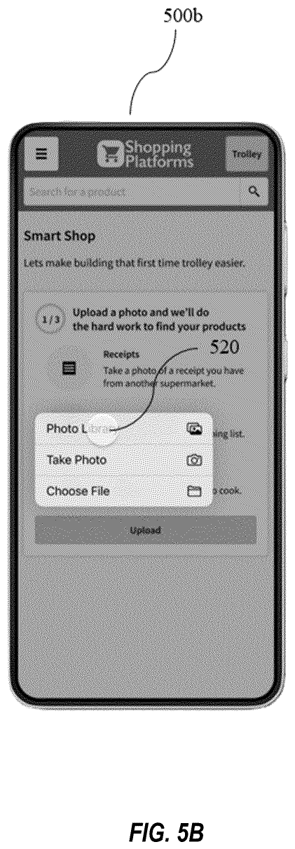

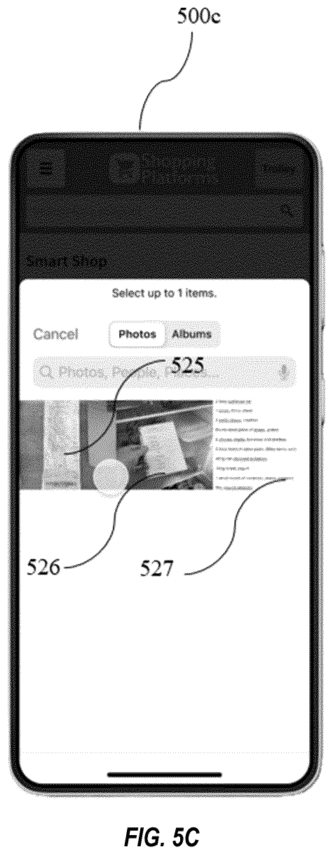

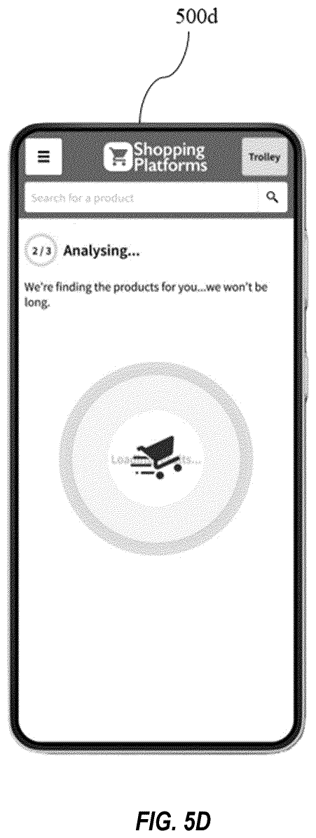

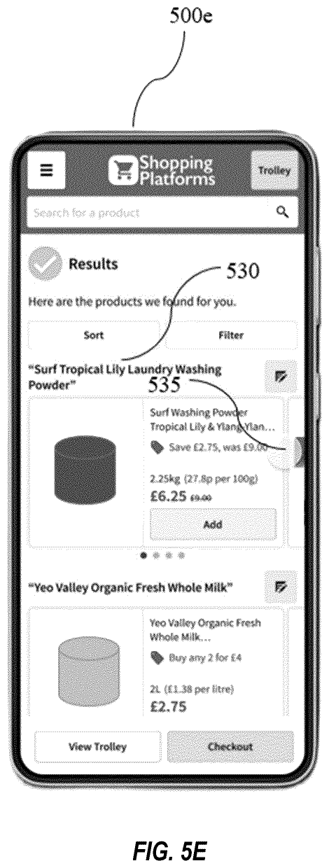

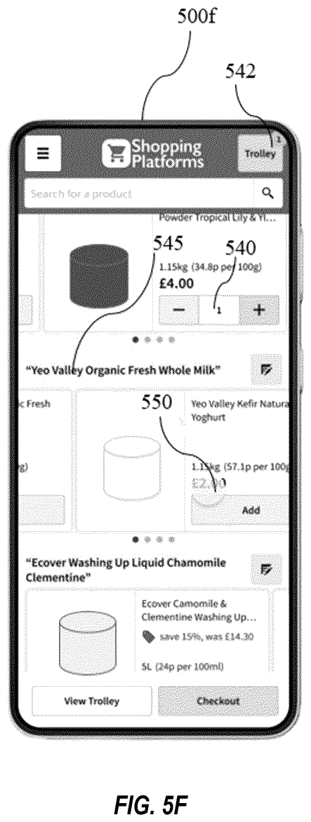

In step 310 (e.g. as shown in FIG. 5A), a user of the client device is prompted to upload a file comprising a list of items. The user may upload a saved file or use a camera of the client device to obtain an image. In any case, the file may be, for example, an online receipt, or an image of a hand written note or an in-store receipt, or a screen capture, or a plain text file. Generally, the file represents a list of items the user is interested in ordering.

In step 320, the file comprising the list of items is sent over a network to the server device.

In step 330, the client device receives, from the server device, for each item of the list of items, data associated with a search (carried out by the server) for at least one identical similar item on the ecommerce platform. Assuming an identical or similar item is unavailable, the unavailability of at least one identical or similar item will be indicated on the client device.

In step 340 (e.g. as shown in FIGS. 5E and 5F), the client device displays the identical or similar items for each item available on the ecommerce platform. The user can interact with each of the at least one identical or similar item and select a preferred item.

In step 350, the selection is sent to the server device to add the preferred items to the user's order. Step 350 may occur upon each selection of an identical or similar item and thus provide feedback that an item has been ordered on an item by item basis. Alternatively, step 350 may occur after selection of all identical and/or similar items has occurred, and thus add the items to an order using a single communication with from the client to server device, where the single communication has the identical item, and/or an equivalent item and/or a substitute, for each item.

After step 350, the user may confirm and pay for the order by communicating with the server in known ways. From the user's perspective, after uploading a file comprising a list of items to the server device, items can be added to an order without the user having to use the search function directly. This significantly reduces the processing and communication resources required and makes it easier for a new user to place an order. To the user, the display of similar items for selection is almost instant. These advantages are significant when the list of items is large, such as a grocery order.

In an alternative example, as explained above for FIG. 2, sending the file alone is sufficient to create the order. This means the user does not have to manually select items to create the order, i.e. steps 330, 340, & 350 are omitted, and the order is automatically created.

The method of FIG. 3 allows an order to be submitted using minimal client-server interactions, which in turn reduces processing and communication resources, and consequently power usage and network resources. In particular, the mere input of the file alone to the client device is sufficient to add items to the order when only one identical or similar item is returned for each item and automatically added to the order. That is, the sole transmission of the file from the client device to the server device is sufficient to place the order, which in turn reduces processing and communication resources at the first device. Even if the selection of which identical or similar items to add to the order is required, this can be achieved without first having to submit search queries via the first device for each item, which in turn reduces processing and communication resources at the first device. Similarly, the mere receipt of the file alone at the server device is sufficient to add items to the order when only one identical or similar item is returned for each item and automatically added to the order. That is, the sole receipt of the file from the client device to the server device is sufficient to place the order, which in turn reduces processing and communication resources at the second device. Even if the selection of identical or similar items to add to the order is required, this can be achieved without first having to receive and process search queries from the first device for each item, which in turn reduces processing and communication resources at the second device.

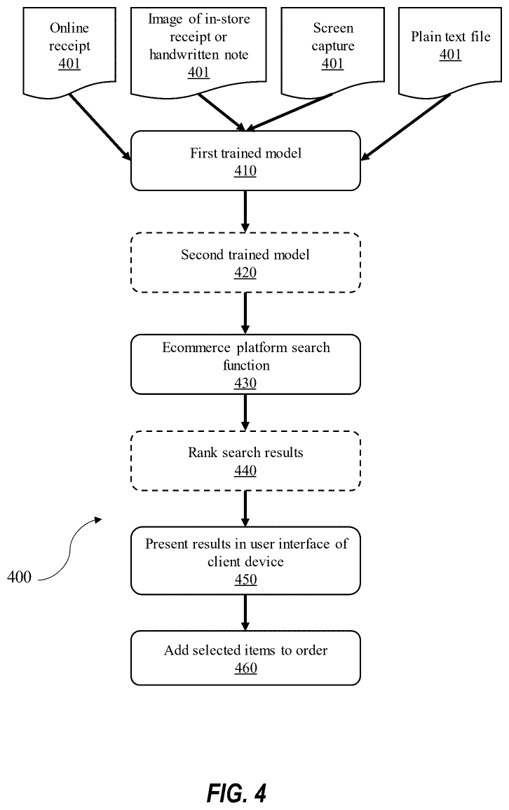

FIG. 4 shows an example of logical elements 400 implemented by the programming of the server device. The server is set up to receive a number of alternative file types 401, such as an online receipt, an image of an in-store receipt or a handwritten note, a screen capture, or a plain text file, or any other file type that contains a list of items. The first trained model element 410 can receive the file directly or indirectly (perhaps via optical character recognition software or a vision LLM for example). In either case, the first trained model is prompted to extract the list of items and generate search terms. If used, the optional second trained model element 420 uses the search terms generated by the first trained model as a seed to generate modified search terms. The search terms are then used in ecommerce platform's search function 430 to generate respective sets of identical or similar items. Optionally, the search results may be ranked at rank element 440, which impacts how the sets of similar items are presented to the user on a UI, such as depicted in FIGS. 5E and 5F. The user device uses element 450 to present results in a user interface of the client device. Upon receipt of a user's item selections, element 460 will add the items to the order. Examples of the data generated by the logical elements in FIG. 4 are shown below.

| | Example 1 | Example 2 |
|---|---|---|
| Seed generated by first | Brand A Revitalize Super | Brand D Flamegrilled Roast |
| trained model | Smoothie | Chicken Slices |
| Search term generated by | Fruit Smoothie | Roast Chicken Slices |
| second trained model and | | |
| seed | | |
| Search results | Brand B Strawberry & | Brand B British Roast |
| | Banana smoothie; Brand A | Chicken Slices; Brand D |
| | Kids Super Smoothie, | British Sliced Roast Chicken; |
| | Strawberry, Kiwi, & Apple; | Brand D British Sliced Roast |
| | Brand C Raw Vitalize Virgin | Chicken Breast |
| | Smoothie | |

FIGS. 5A-F show example user interface 500a-f of the client device when carrying out the method of FIG. 3. In the following example, the client device has a touch-sensitive display (for example running iOS™ or Android®, provided by Apple® and Google® respectively). In 500a the user is presented with a window 515 prompting the user to start the method of FIG. 3 by interacting with user interface element 510. Upon receiving user interface input 505, user interface 500b is presented where the user can upload a file comprising a list of items. In the example shown, a photo library is selected 520 as the source for the user file. A grocery receipt is selected 525 in user interface 500c. As shown in 500c, the user could alternatively select an image of a handwritten note 526 or a screen grab 527 where both contain a list of items. The user interface in 500d is presented with an indication that identical or similar products are being found. In screen 500e, the identical or similar items are shown for an item on the list 530. As mentioned above, if a similar item is unavailable, the unavailability of a similar item will be indicated (this scenario not shown in FIGS. 5E and 5F. The identical or similar items may be scrolled in a horizontal direction (e.g., right and left on the screen) via 535 for selection. User interface 500f shows that an identical or similar item for 530 has been selected and added 540 to the basket as shown by the badge on element 542. User interface 500f also shows an interface element 550 for adding an item 545 to the basket. The above sequence of user interfaces 500a-f are one example only of how the method of FIG. 3 may be executed on the client device.

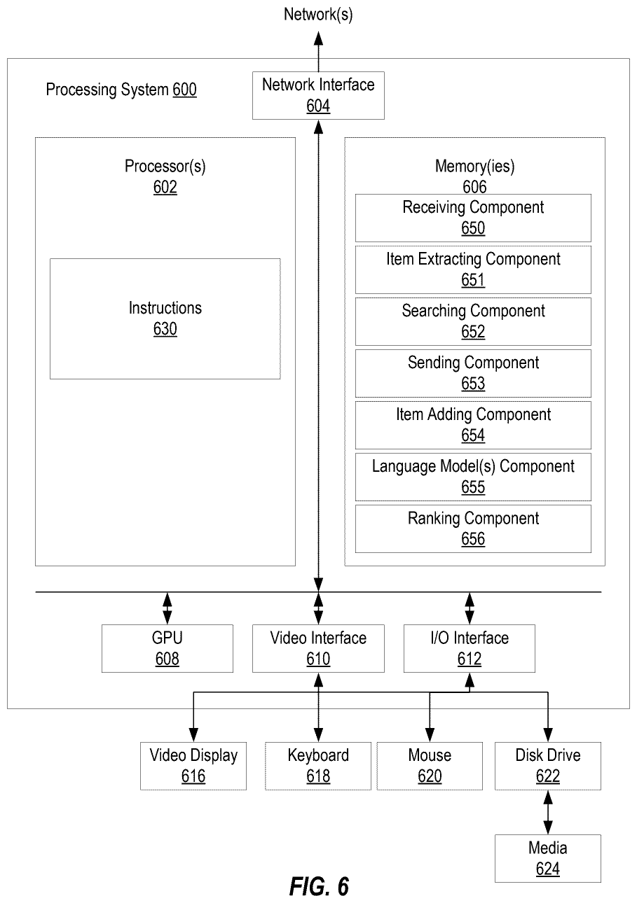

FIG. 6 depicts a processing system 600 for implementing aspects described. In some aspects, processing 600 may be a server device configured to perform method 200 of FIG. 2 and implement logical elements from FIG. 4.

In this example, processing system 600 includes one or more one or more processors 602 configured to retrieve and execute instructions stored in one or more memories 606, which may be volatile memory, such as a random access memory (RAM), or a nonvolatile memory, such as nonvolatile random access memory (NVRAM), or the like. In this example, the one or more memories 606 include a receiving component 650, an item extracting component 651, a searching component 652, a sending component 653, an item adding component 654, language model(s) component 655, and ranking component 656.

The receiving component 650 may be configured to perform at least steps 210 and 250 of method 200 described with reference to FIG. 2,

The item extracting component 651 may be configured to perform at least step 220 of method 200 described with reference to FIG. 2.

The searching component 652 may be configured to perform at least step 230 of method 200 described with reference to FIG. 2 and to implement logical component 430 of FIG. 4.

The sending component 653 may be configured to perform at least step 240 of method 200 described with reference to FIG. 2.

The item adding component 654 may be configured to perform at least step 260 of method 200 described with reference to FIG. 2 and to add selected item component 460 of FIG. 4.

The language model component 655 may implement, for example, the first and second trained models as described with respect to step 220 of FIG. 2 as well as logical components 410 and 420 of FIG. 4.

The ranking component 656 may implement, for example, ranking component 440 of FIG. 4.

The one or more memories 606 may include various additional components or data useful for performing described methods in accordance with presently described aspects.

Instructions 630 may generally implement any of components 650-656 for processing by the one or more processors 602.

Processing system 600 may further include a graphics processing unit (GPU) 608 which is operatively connected to the one or more processors 602 and to the one or more memories 606 to offload relevant data from the one or more processors 602 and process data in parallel with the one or more processors 602. Processing system 600 may further include a video display 616 connected by a video interface 610, and various input/output devices such as a keyboard 618, mouse 620, and disk drive or solid state drive 622 connected by an I/O interface 612. In a known manner, the mouse 612 may be configured to control movement of a cursor in a video display 616, and to operate various graphical user interface (GUI) controls appearing in the video display 616 with a mouse button. The disk drive or solid state drive 622 may be configured to accept computer readable media 624.

The processing system 600 may send and receive data over a network via a network interface 604, allowing the processing system 600 to communicate with other suitably configured data processing systems, applications, or devices. Network interface 604 may generally provide data access to any sort of data network, including personal area networks (PANs), local area networks (LANs), wide area networks (WANs), the Internet, and the like.

Processing system 600 may be implemented in various ways. For example, processing system 600 may be implemented within on-site, remote, or cloud-based processing equipment.

It will be appreciated by those skilled in the art that other variations of the embodiments described herein may also be practiced without departing from the scope of the invention. Other modifications are therefore possible.

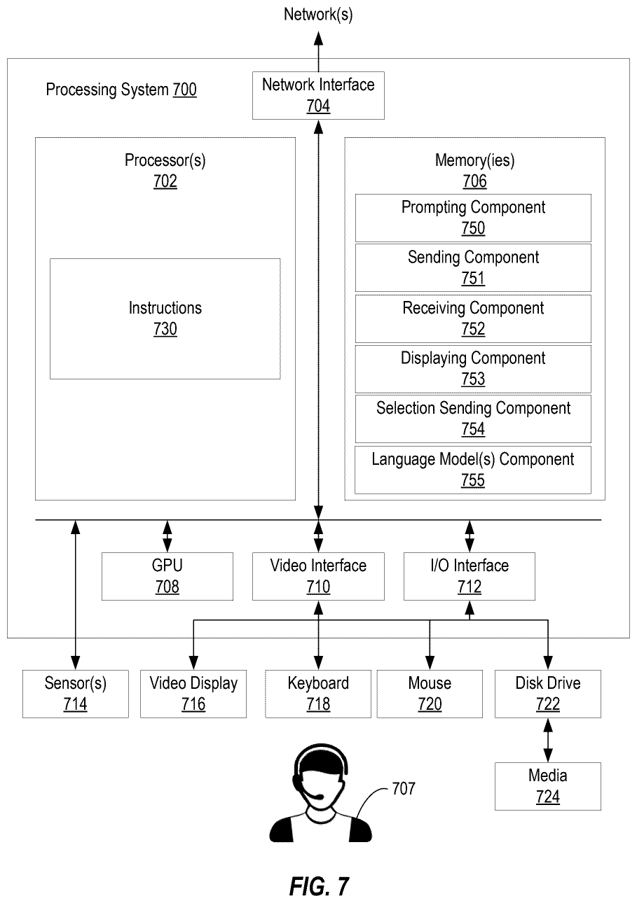

FIG. 7 depicts a processing system 700 for implementing aspects described herein. In some aspects, processing 600 may be a client device configured to perform method 300 of FIG. 3 and implement logical elements from FIG. 4.

Processing system 700 may include one or more processor) 702 configured to retrieve and execute instructions stored in one or more memories 706.

In this example, the one or more memories 706 may include at least a prompting component 750, a sending component 751, a receiving component 752, a displaying component 753, a selection sending component 754, and a language model(s) component 755.

The prompting component 750 may be configured to perform at least step 310 of method 300 described with reference to FIG. 3,

The sending component 751 may be configured to perform at least step 320 of method 300 described with reference to FIG. 3.

The receiving component 752 may be configured to perform at least step 330 of method 300 described with reference to FIG. 3.

The displaying component 753 may be configured to perform at least step 340 of method 300 described with reference to FIG. 3.

The selection sending component 754 may be configured to perform at least step 350 of method 300 described with reference to FIG. 3.

Though described above as being implemented by the server device, in some aspects the client device (e.g., processing system 700) may implement one or both of the first trained model and the second trained model with language model component 755.

The one or more memories 706 may include various additional components or data useful for performing described methods in accordance with presently described aspects.

Instructions 730 may generally implement any of components 750-755 for processing by the one or more processors 702.

Processing system 700 may further include a graphics processing unit (GPU) 708 which is operatively connected to the one or more processors 702 and the one or more memories 706 to offload relevant data from the one or more processors 702 and to process data in parallel with the one or more processors 702. An operator 707 may interact with the processing system 700 using a video display 716 connected by a video interface 710, and various input/output devices such as a keyboard 718, mouse 720. In aspects, keyboard 718 or mouse 720 may be virtual components. Processing system 700 may further include a disk drive or solid state drive 722 connected by an I/O interface 712. In a known manner, the mouse 712 may be configured to control movement of a cursor in a video display 716, and to operate various graphical user interface (GUI) controls appearing in the video display 716 with a mouse button. The disk drive or solid state drive 722 may be configured to accept computer readable media 724.

The processing system 700 may form part of a network via a network interface 704, allowing the processing system 700 to communicate with other suitably configured data processing systems, applications, or devices. Network interface 704 may generally provide data access to any sort of data network, including personal area networks (PANs), local area networks (LANs), wide area networks (WANs), the Internet, and the like.

In some aspects, processing system 700 may be configured to implement the user interfaces of FIGS. 5A-F to allow performing an electronic data transaction (e.g., placing an order on an ecommerce website) using minimal client server interactions, which reduces processing and communication resources, and consequently power usage and network resources.

In some aspects, an application implemented on a client device may be implemented as a web service, where the client device includes a link for accessing the web service, rather than a native application. The functionality described may be implemented to any mobile platform, including the iOS™ platform, ANDROID™, WINDOWS™ or BLACKBERRY™

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

### Example Aspects

The following is a list of aspects which may be or are claimed.

Aspect 1. A computer-implemented method, the method comprising: receiving, from a first device, a file comprising a list of items; processing, using a first trained model, the file to extract the list of items; searching, for each item of the list of items, for at least one identical or similar item; sending, to the first device, for each item of the list of items, data associated with the searching for the at least one identical or similar item; receiving, from the first device, at least one selection of the at least one identical or similar item; and adding items corresponding to the at least one selection of the at least one identical or similar item to an order for a system for conducting an electronic data transaction.

Aspect 2. The computer-implemented method of aspect 1, wherein the first trained model comprises a first language model.

Aspect 3. The computer-implemented method of aspect 2, wherein the method further comprises using a prompt for the first language model to extract the list of items.

Aspect 4. The computer-implemented method of any one of aspects 1-3, wherein the method further comprises generating a respective search term for searching each item of the list of items.

Aspect 5. The computer-implemented method of aspect 4, wherein generating the respective search term for searching each item of the list of items comprises using a second trained model.

Aspect 6. The computer-implemented method of aspect 5, wherein the second trained model comprises a second language model.

Aspect 7. The computer-implemented method of aspect 6, wherein the method further comprises using a prompt for the second language model to generate the search term for searching each item of the list of items.

Aspect 8. The computer-implemented method of any one of aspects 1-7, wherein the method further comprises, for each item, ranking the at least one identical or similar item.

Aspect 9. The computer-implemented method of any one of aspects 1-8, wherein the method further comprises moving the items corresponding to the at least one selection of the at least one identical or similar item, to an electronic basket or cart or trolley of the system for conducting an electronic data transaction.

Aspect 10. The computer-implemented method of any one of aspects 1-9, wherein the file comprises an online receipt, or an image of an in-store receipt, or image of a handwritten note, or a screen capture, or a plain text file.

Aspect 11. The computer-implemented method of any one of aspects 1-10, wherein the method further comprises processing payment details to complete the order.

Aspect 12. A computer-implemented method, the method comprising: prompting a user to upload a file comprising a list of items; sending the file to a second device; receiving, from the second device, for each item of the list of items, data associated with searching for at least one identical or similar item; displaying, for each item of the list of items, the data associated with the searching for at least one identical or similar item; and sending at least one selection of the at least one identical or similar items to the second device to add items corresponding to the at least one selection of the at least one identical or similar item to an order for a system for conducting an electronic data transaction.

Aspect 13. The computer-implemented method of aspect 12, wherein the method further comprises displaying, for each item, the data associated with the searching for at least one identical or similar item in response to an input moving along the at least one identical or similar item and/or each item.

Aspect 14. The computer-implemented method of any one of aspects 12-13, wherein the method further comprises displaying a user interface element to select the at least one identical or similar item.

Aspect 15. The computer-implemented method of any one of aspects 12-14, wherein the method further comprises displaying, for each item, the at least one identical or similar item side-by-side.

Aspect 16. The computer-implemented method of any one of aspects 12-15, wherein the method further comprises displaying each item and its respective at least one identical or similar item row by row.

Aspect 17. The computer-implemented method of any one of aspects 12-16, wherein the method further comprises displaying that the items corresponding to the at least one selection of the at least one identical or similar item are in an electronic basket or cart or trolley of the system for conducting an electronic data transaction.

Aspect 18. The computer-implemented method of any one of aspects 12-17, wherein the file comprises an online receipt, or an image of an in-store receipt, or image of a handwritten note, or a screen capture, or a plain text file.

Aspect 19. The computer-implemented method of any one of aspects 12-18, wherein the method further comprises processing payment details to complete the order.

Aspect 20. A processing system, comprising: a memory comprising computer-executable instructions; and a processor configured to execute the computer-executable instructions and cause the processing system to: perform the method of any one of aspects 1-19.

Aspect 21: A non-transitory computer-readable medium storing program code for causing a processing system to perform the steps of any one of aspects 1-19.

1. A computer-implemented method comprising:
receiving, from a first device via network, an uploaded file comprising a list of items, wherein the uploaded file comprises an online receipt, an image of an in-store receipt, an image of a handwritten note, a screen capture, or a plain text file, and wherein the uploaded file is received based on a user-selected existing file for upload that is saved on the first device to reduce processing time at the first device for obtaining the list of items;
processing, using a first trained model, the uploaded file to extract a first search term for each item in the list of items based on a prompt, wherein the first search term for each item in the list of items comprises an extracted product name for each respective item in the list of items;
implementing the extracted product name as a seed for generating a second prompt;
prompting, using the second prompt, a second trained model to generate a second search term for each respective item in the list of items by generating a broader term associated with the extracted product name for each respective item in the list of items;
searching, using a batch search function, for each item of the list of items, for at least one identical or similar item based on the second search term for each respective item in the list of items, wherein the batch search function returns data comprising a set of results;
sending, to the first device, for each item of the list of items, the data for displaying the at least one identical or similar item within a ranked list of items via a user interface of the first device, wherein the data is associated with the at least one identical or similar item for each item in the list of items based on the searching using the second search term;
receiving, from the first device, at least one selection of the at least one identical or similar item; and
adding items corresponding to the at least one selection of the at least one identical or similar item to an order for a system for conducting an electronic data transaction.

2. The computer-implemented method of claim 1, wherein the first trained model comprises a first language model.

3-7. (canceled)

8. The computer-implemented method of claim 1, further comprising, for each item, ranking the at least one identical or similar item.

9. The computer-implemented method of claim 1, further comprising moving the items corresponding to the at least one selection of the at least one identical or similar item, to an electronic basket or cart or trolley of the system for conducting the electronic data transaction.

10. (canceled)

11. The computer-implemented method of claim 1, further comprising processing payment details to complete the order.

12-19. (canceled)

20. A processing system, comprising: one or more memories comprising computer-executable instructions; and one or more processors configured to execute the computer-executable instructions and cause the processing system to:
receive, from a first device, an uploaded file comprising a list of items, wherein the uploaded file comprises an online receipt, an image of an in-store receipt, an image of a handwritten note, a screen capture, or a plain text file, and wherein the uploaded file is received based on a user-selected existing file for upload that is saved on the first device to reduce processing time at the first device for obtaining the list of items;
process, using a first trained model, the uploaded file to extract a first search term for each item in the list of items based on a prompt, wherein the first search term for each item in the list or items comprises an extracted product name for each respective item in the list of items;
implement the extracted product name as a seed for generating a second prompt;
prompt, using the second prompt, a second trained model to generate a second search term for each respective item in the list of items by generating a broader term associated with the extracted product name for each respective item in the list of items;
search, using a batch search function, for each item of the list of items, for at least one identical or similar item based on the second search term for each respective item in the list of items, wherein the batch search function returns data comprising a set of results;
send, to the first device for each item of the list of items, data for displaying the at least one identical or similar item within a ranked list of items via a user interface of the first device, wherein the data is associated with the at least one identical or similar item for each item in the list of items based on the searching using the second search term;
receive, from the first device, at least one selection of the at least one identical or similar item; and
add items corresponding to the at least one selection of the at least one identical or similar item to an order for a system for conducting an electronic data transaction.

21. The computer-implemented method of claim 1, wherein the second prompt further comprises instructions for causing the second trained model to generate and return the second search term in a JavaScript Object Notation (JSON) format, and the computer-implemented method further comprising: receiving the second search term in the JSON format.

22. The computer-implemented method of claim 1, wherein searching, using the batch search function, for each item of the list of items, for at least one identical or similar item based on the second search term for each respective item in the list of items further comprises determining, using a substitution algorithm, a set of substitute items for each item of the list of items, wherein the substitution algorithm comprises a set of variables based on a set of similarity metrics for comparing each item of the list of items with a set of available items.

23. The computer-implemented method of claim 22, wherein the set of similarity metrics are associated with one or more of an item's weight, volume, or item description.

24. The computer-implemented method of claim 1, wherein searching, using the batch search function, for each item of the list of items, for at least one identical or similar item based on the second search term for each respective item in the list of items further comprises determining a set of substitute items for each item of the list of items based on a set of predefined substitution items for each respective item in the list of items.

25. The computer-implemented method of claim 1, wherein the ranked list of items is organized based on similarity of one or more of price, size, or weight for the at least one identical or similar item for each item of the list of items.

26. The computer-implemented method of claim 1, further comprising sending, to the first device, additional data for displaying an indication that one or more of the items of the list of items is unavailable.

27. The processing system of claim 20, wherein the second prompt further comprises instructions for causing the second trained model to generate and return the second search term in a JavaScript Object Notation (JSON) format, and the one or more processors are further configured to cause the processing system to receive the second search term in the JSON format.

28. The processing system of claim 20, wherein to search, using the batch search function, for each item of the list of items, for at least one identical or similar item based on the second search term for each respective item in the list of items, the one or more processors are further configured to cause the processing system to determine, using a substitution algorithm, a set of substitute items for each item of the list of items, wherein the substitution algorithm comprises a set of variables based on a set of similarity metrics for comparing each item of the list of items with a set of available items.

29. The processing system of claim 28, wherein the set of similarity metrics are associated with one or more of an item's weight, volume, or item description.

30. The processing system of claim 20, wherein to search, using the batch search function, for each item of the list of items, for at least one identical or similar item based on the second search term for each respective item in the list of items, the one or more processors are further configured to cause the processing system to determine a set of substitute items for each item of the list of items based on a set of predefined substitution items for each respective item in the list of items.

31. The processing system of claim 20, wherein the ranked list of items is organized based on similarity of one or more of price, size, or weight for the at least one identical or similar item for each item of the list of items.

32. The processing system of claim 20, wherein the one or more processors are further configured to cause the processing system to further send, to the first device, additional data for displaying an indication that one or more of the items of the list of items is unavailable.
